(19) United States
(12) Patent Application Publication
(10) Pub. No.: US 2009/0046807 A1
(43) Pub. Date: Feb. 19, 2009

(54) Method and system for beamforming communication in wireless communication systems

(75) Inventors: Pengfei Xia, Mountain View, CA (US); Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/893,448

(22) Filed: Aug. 16, 2007

(51) Int. Cl. H04L 27/00

(52) U.S. Cl. 375/299

(57) ABSTRACT

A method and system for beamforming communication in a wireless communication system that includes a wireless initiator and a wireless responder is provided. A channel matrix is estimated at the responder. The singular value decomposition of the channel matrix yields the right singular matrix, which is further deconstructed into certain components. The right singular matrix components are quantized in a vector fashion and fed back to the initiator for reconstruction and beamforming communication.

### FIELD OF THE INVENTION

The present invention relates to beamforming in wireless communication systems, and in particular to beamforming in multiple-input-multiple-output (MIMO) wireless communication systems.

### BACKGROUND OF THE INVENTION

In a MIMO wireless communication system including a wireless transmitter and a wireless receiver, availability of accurate communication channel state information at the transmitter allows higher throughput. Transmit beamforming uses the channel information for determining beamforming coefficients (beamforming/steering vectors) to properly steer the transmission beams for achieving higher throughput. To calculate the beamforming vector for a specific receiver, the transmitter requires an accurate estimate of the communication channel.

There are generally two approaches for acquiring information for estimating a channel from the transmitter to the receiver. One approach involves implicit feedback, while another approach involves explicit feedback. With implicit feedback, the transmitter (or initiator) receives a sounding packet from the receiver (or responder) and estimates the channel state information using channel reciprocity. Generally, channel reciprocity requires calibrated radio frequency (RF) chains in MIMO systems and further requires that the forward/reverse communication links operate in the time division duplex (TDD) mode.

With explicit feedback, the responder makes a direct estimate of the channel and sends information based on channels estimates back to the initiator. The initiator computes the steering vectors using the channel estimate returned by the responder. In some conventional approaches where explicit feedback of non-compressed steering matrix is performed, the required feedback requires 2×Nss×N×Nb bits where Nb is the number of bits to represent each real number, Nss is the number of data streams in the MIMO systems, and N is the number of transmit antennas. In other approaches, the channel estimates are compressed by encoding, requiring 2×Nss×N×Nb feedback bits. As such, conventional approaches incur high transmission overhead for explicit feedback of channel information.

### BRIEF SUMMARY OF THE INVENTION

The present invention provides a method and system for beamforming in wireless communication systems. One embodiment involves explicit feedback beamforming for a wireless communication system including an initiator (transmitter) and a responder (receiver), by quantization of a right singular matrix corresponding to the original channel matrix.

One implementation involves estimating the channel matrix at the responder, obtaining a right singular matrix from the estimated channel matrix by singular value decomposition, deconstructing the right singular matrix into certain components, and quantizing the right singular matrix components for feedback to the initiator. The right singular matrix is then reconstructed at the initiator using the quantized version, by aligning the components in correct order. A beamforming matrix is then obtained as the reconstructed right singular matrix and used as the beamformer to steer transmission data in the spatial domain.

In another implementation the right singular matrix is deconstructed column-by-column into columns quantized in a column-by-column manner (column-wise), by performing vector quantization for each column. The quantized right singular matrix is fed back to the initiator. The right singular matrix is then reconstructed at the initiator by aligning columns in the proper order at the transmitter side.

In yet another implementation, the right singular matrix is deconstructed row-by-row and quantized in a row-by-row manner (row-wise), by performing vector quantization for each row. The quantized right singular matrix is fed back to the initiator. The right singular matrix is then reconstructed at the initiator by aligning rows in the proper order at the transmitter side. An example of such a wireless communication system is a MIMO communication system.

These and other features, aspects and advantages of the present invention will become understood with reference to the following description, appended claims and accompanying figures.

### BRIEF DESCRIPTION OF THE DRAWINGS

FIG. 1 shows an example of a functional block diagram of a wireless communication system including a transmitter (initiator) and a receiver (responder) that implement explicit channel feedback for transmit beamforming, according to an embodiment of the present invention.

FIG. 2 shows a functional block diagram for a transmitter in the communication system of FIG. 1, according to an embodiment of the present invention.

FIG. 3 shows a functional block diagram for a receiver in the communication system of FIG. 1, according to an embodiment of the present invention.

FIG. 4 shows a flowchart of the steps of an embodiment of explicit feedback beamforming implemented in the communication system of FIG. 1, according to an embodiment of the present invention.

FIG. 5 shows a functional block diagram of a wireless MIMO OFDM (orthogonal frequency division multiplexing) communication system, according to an embodiment of the present invention.

In the drawings, like references, refer to similar elements.

### DETAILED DESCRIPTION OF THE INVENTION

The present invention provides a method and system for beamforming in wireless communication systems. One embodiment involves explicit feedback of channel information from a responder (receiver) to an initiator (transmitter) for transmit beamforming in a MIMO wireless communication system, using quantization of the right singular matrix.

In one implementation, the right singular matrix of the communication channel is deconstructed into components, such as column-by-column (column-wise) or row-by-row (row-wise), and quantized in a column-by-column (column-wise), or row-by-row (row-wise), manner at the responder. The quantized right singular matrix components are fed back to the initiator. At the initiator, the right singular matrix is then reconstructed and used for beamforming communication. This enables use of a simplified codebook design, reducing codebook storage requirement at both the initiator and the responder, and also reducing receiver complexity.

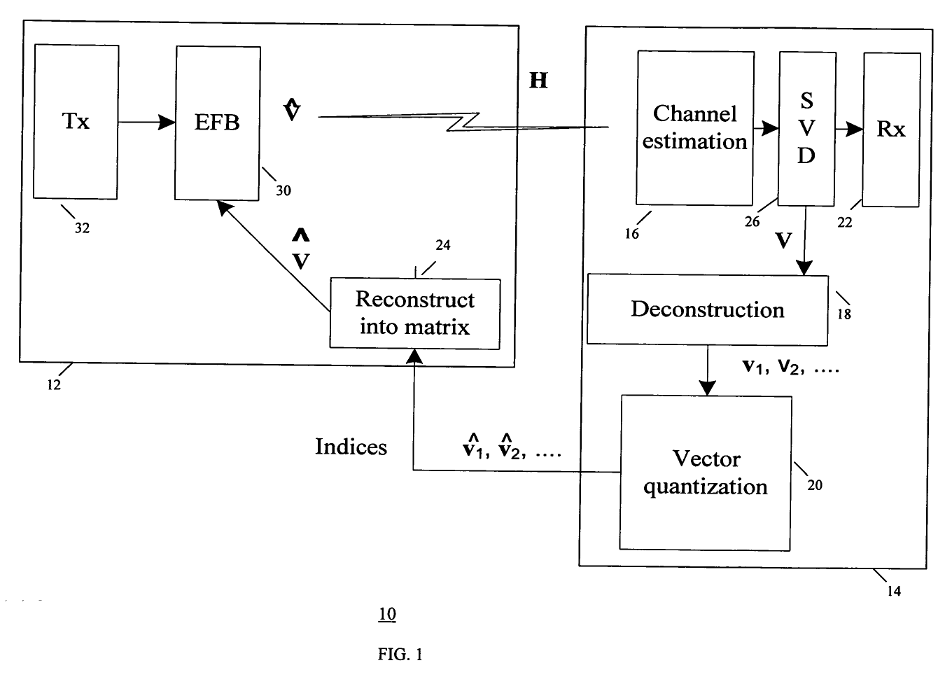

FIG. 1 shows an example functional block diagram of a wireless MIMO communication system 10 including an initiator 12 (transmitting station) and a responder 14 (receiving station) that implement explicit channel feedback by quantization of the right singular matrix for transmit beamforming, according to an embodiment of the present invention.

In the responder 14, an estimator 16 estimates the channel matrix H based on training symbols from the initiator 12. Then a right singular matrix V is calculated by a SVD function 26 of the responder 14 based on the channel matrix H. The right singular matrix V is then deconstructed in a column-by-column (column-wise) manner into columns (v₁, v₂, . . . ) by a matrix deconsctructer 18 and then quantized by a quantizer 20.

The column-wise quantized right singular matrix is fed back to the initiator 12 and reconstructed into a right singular matrix \hat{V} by a reconstructer (combiner) 24. The reconstructed right singular matrix \hat{V} is then used as the beamforming matrix by the explicit feedback beamformer (EFB) 30 to steer data from a transmit function (Tx) 32 in the spatial domain.

A frame structure is used for data transmission between the initiator and the responder. For example, frame aggregation in a Media Access Control (MAC) layer and a physical (PHY) layer is implemented. In the initiator, a MAC layer attaches a MAC header to a MAC Service Data Unit (MSDU) in order to construct a MAC Protocol Data Unit (MPDU). The MAC header includes information such as source addresses (SA) and a destination address (DA). The MPDU is a part of a PHY Service Data Unit (PSDU) and is transferred to a PHY layer in the initiator to attach a PHY header (i.e., PHY preamble) thereto to construct a PHY Protocol Data Unit (PPDU). The PHY header includes parameters for determining a transmission scheme including a coding/modulation scheme. Before transmission as a packet from a transmitter to the responder, a preamble is attached to the PPDU, wherein the preamble can include channel estimation and synchronization information.

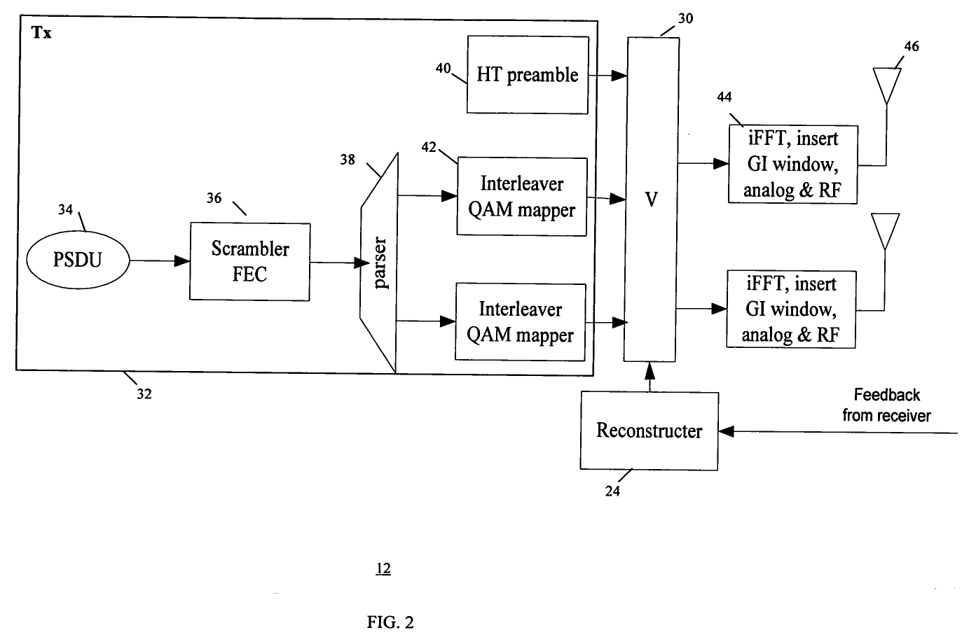

FIG. 2 shows a more detailed functional block diagram of the MIMO initiator 12. The Tx function 32 of the initiator 12 comprises a PSDU 34, a scrambler/forward error correction (FEC) function 36, a parser 38, a high throughput (HT) preamble insertion function 40, multiple interleaver (QAM) mapping modules 42. The initiator 12; further includes an explicit feedback transmit beamforming function (V function) 30, multiple stream processors 44, and multiple (N) transmit antennas 46.

Data to be transmitted is collected as the PSDU 34 to generate PSDUs. The scrambler and forward error correction (FEC) encoder 36 are applied sequentially to randomize the PSDUs and to add encoding for protection against channel errors, respectively. The parser 38 distributes the randomized and encoded data into multiple streams so that the data streams can be processed in parallel by multiple processing paths.

In each processing path, the interleaver function of each module 42 shuffles the data to provide better channel error protection. The QAM mapper function of each module 42 modulates the binary data into symbols that can be transmitted. The HT preamble function 40 inserts an HT preamble for every PSDU so that the receiver can synchronize with the transmitter in frequency/time and can estimate the channel H. The explicit feedback transmit beamforming function 30 steers the transmitted signal to increase reception quality at the receiver. An inverse Fast Fourier Transform (iFFT)/guard interval (GI) insertion/windowing function 44 completes the modulation (e.g., OFDM) at the initiator 12.

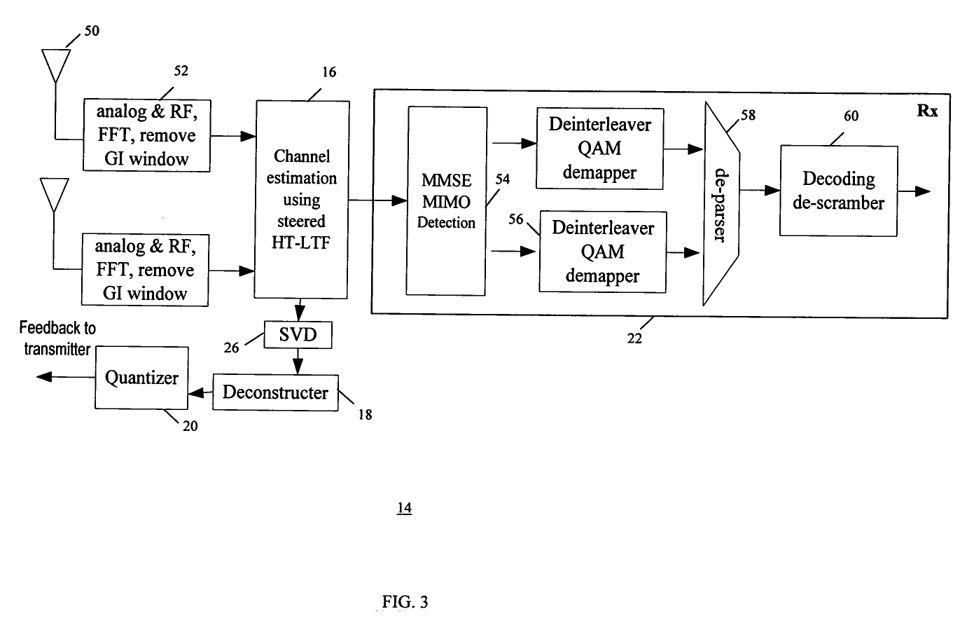

FIG. 3 shows a more detailed functional block diagram of the MIMO responder 14. The responder 14 includes said channel estimator 16, said matrix deconstructer 18, said quantizer 20, multiple (Nᵣ) receive antennas 50 and multiple stream processors 52. The Rx function 22 further includes a minimum mean squared error (MMSE) MIMO detector 54, multiple deinterleaver QAM demappers 56, a deparser 58 and a decoding descrambler 60. After the analog radio frequency (RF) chain, the FFT/GI removal/windowing function 52 of each processing stream completes the modulation (e.g., OFDM) at the receiver. The MMSE MIMO detector 54 detects the transmitted symbols. The deinterleaver 56 reshuffles the data back into their original order and the QAM demapper 56 performs the inverse operation of the QAM mapper 42. The deparser 58 multiplexes the multiple streams into a single stream. The decoding and descrambling function 60 inverts the function of the scrambling/FEC encoding function 36 of the receiver.

The channel matrix H is estimated by the estimator 16 and the right singular matrix V is calculated by the singular value decomposition (SVD) function 26 based on the channel matrix H. The right singular matrix V is deconstructed in a column-by-column (column-wise) manner into N columns vᵢ (i.e., v₁, v₂, . . . , v_{N}) by the matrix deconsctructer 18 and then quantized by a quantizer 20. Each column vᵢ is sequentially vector-quantized by the quantizer 20 into a quantized column \hat{v}ᵢ using a codebook Ω. Because statistics of each column do not differ much from others, the same codebook can be used for all columns of the singular vector V. The codebook Ω can be represented as:

Ω={w₁, . . . , w_{K}},

wherein K is the codebook size for vector quantization, and every wᵢ is a candidate beamforming vector of dimension N×1.

The quantized columns \hat{v}ᵢ (i.e., indices in FIG. 1) are then fed back to the initiator 12. Upon receiving the indices from the responder 14, the reconstructer 24 of the initiator 12 reconstructs the right singular matrix \hat{V} by combining the quantized columns together in the correct order, as:

\hat{V}=[\hat{v}₁, \hat{v}₂ . . . ].

Because of channel randomness, it is impossible to maintain \hat{V} as a unitary matrix. As such, the reconstructed matrix \hat{V} is normalized as:

$$V = \frac{{V}^{⋒}}{\sqrt{trace ( \hat{V} {{V}^{⋒}}^{H} )}} ,$$

which is used for beamforming at the initiator 12 by the EFB 30 to steer data from Tx 32 in the spatial domain.

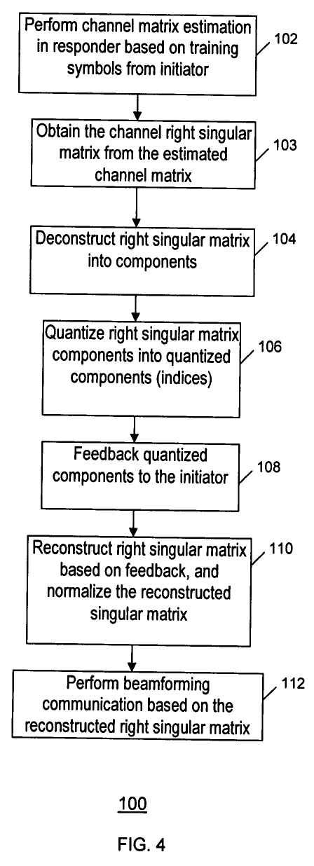

FIG. 4 shows a process 100 for explicit feedback beamforming for a wireless MIMO communication system such as the example MIMO system 10 in FIG. 1, according to an embodiment of the present invention. The process 100 includes the steps of:
Step 102: Communication channel estimation. The channel matrix is estimated by the estimator 16 of the responder 14 based on training symbols from the initiator 12.
Step 103: Singular Value Decomposition. Perform singular value decomposition of the estimated channel matrix using the SVD 26 to obtain the right singular (unitary) matrix V.
Step 104: Deconstruction of the right singular matrix. Naturally deconstruct the right singular matrix V into components, e.g., N columns (v₁, v₂, . . . , V_{N}).
Step 106: Quantization of the singular matrix components. Quantize each component (e.g., column vᵢ) of the right singular matrix separately via the quantizer 20 into quantized columns \hat{v}ᵢ (indices). The quantization is based on the closest codeword from codebook Ω such that a certain distortion metric is minimized. One example is provided below (other performance metrics can also be used):

$${\hat{v}}_{i} = arg {min}_{{w}_{i} ∈ Ω} ( 1 - {\vert {w}_{i}^{H} v \vert}^{2} ) .$$

Step 108: Feedback of singular information to the initiator. The quantized right singular matrix components (e.g., columns \hat{v}ᵢ) including decision bits for the right singular matrix direction and for the strength, are then fed back separately from the responder 14 to the initiator 12.
Step 110: Reconstruction of the right singular matrix (i.e., the beamforming matrix). Each right singular matrix component (e.g., column) is reconstructed at the initiator 12 by the reconstructer 24 based on the corresponding quantized right singular matrix component (e.g., column). The right singular matrix \hat{V} is then reconstructed by placing the matrix components (e.g., columns) in the proper place, as:

\hat{V}=[\hat{v}₁ \hat{v}₂ . . . \hat{v}_{N}]

wherein \hat{v}ᵢ is the reconstructed version of the i^{th} component (e.g., column) of V.
Step 112: Beamforming. The reconstructed right singular matrix is then normalized as:

$$V = \frac{{V}^{⋒}}{\sqrt{trace ( \hat{V} {{V}^{⋒}}^{H} )}} ,$$

wherein the matrix \hat{V} is then used as the beamforming vector by the EFB 30 to steer data from Tx 32 in the spatial domain.

Using explicit feedback transmit beamforming based on component-wise (column-wise or row-wise) quantization of the right singular matrix according to the present invention, the total number of required feedback bits to the initiator 12 is N*log₂(K), where N is the number of transmit antennas and K is the codebook size for vector quantization. This is in contrast to the conventional requirement of 2×Nr×N×Nb feedback bits to provide accurate channel state information to the initiator for transmit beamforming, where Nr is the number of receive antennas, N is the number of transmit antennas and Nb is the number of bits required to represent each real number. As such, the present invention provides a reduction in feedback overhead. The ratio of the required feedback bits according to the present invention compared to the feedback bits according to conventional approaches can be expressed as:

$$\frac{{log}_{2} K}{2 {N}_{r} {N}_{b}} .$$

Generally, log₂(K) is considerably less than the product 2NᵣN_{b}, and thus yielding a considerable amount of saving in terms of number of feedback bits according to the present invention.

An example of constructing the codebook Ω is now described. A systematic algorithm, known as the generalized Lloyd algorithm, is utilized in generating the codebook Ω, where each component of Ω is a beamforming vector of dimension N×1. It is assumed that the channel statistics are known, and can be captured by a random process D.
Step A: Randomly choose a very large collection of channel realizations, □, from the random channel process D. Normally, the total number of realizations in □ is on the order of 10⁵ or higher.
Step B: Initialize Ω with any valid codebook. A codebook is valid if every column wᵢ is normalized, i.e., ∥wᵢ∥=1.
Step C: For the new/updated codebook and every channel realization vᵣ in V, apply the following rule to update the channel space partition:

VᵣεVᵢ if d(h,wᵢ)≦d(v,wⱼ)∀j≠i
Region Vᵢ can be called the neighborhood of codeword wᵢ, while codeword wᵢ is often referred to as the representative (or, head) of region Vᵢ. A certain channel realization hᵣ joins region Vᵢ, if and only if representative wᵢ turns out to be the closest one among all possible representatives w₁, w₂, . . . , w_{K}. Note that each channel realization can be assigned to only one region, and has to be assigned to one region as well. The channel space partition is completed once all channel realizations have been successfully assigned to a certain region.
Step D: For the updated space channel partition in step C, compute the local channel correlation matrix for each region as:

Σᵢ=(1/nᵢ)Σvᵣvᵣ^{H} if vᵣεVᵢ, ∀i=1, . . . , K
wherein nᵢ is the number of channel realizations that fall into region Vⱼ.
Step E: For the new local channel correlation matrix in step D, update every region representative wᵢ with the principal eigenvector of the local channel correlation matrix Σᵢ, i.e., the eigenvector of Σᵢ corresponding to the largest eigenvalue.
Step F: Repeat steps C through E for a number of times until the codebook Ω converges.

The right singular matrix can also be deconstructed at the responder in a row-by-row fashion into Nr rows f₁, f₂, . . . , f_{Nr} and then quantized in a row-by-row manner (row-wise), by performing vector quantization for each row. Specifically, for each row, the singular vector strength and the singular vector direction are quantized separately. The singular vector strength is quantized using scalar quantization and the singular vector direction is quantized using vector quantization. The strength of each row vector is quantized using scalar quantization. The quantized right singular matrix is then fed back to the initiator. At the initiator, the right singular matrix is reconstructed by aligning rows in the proper order.

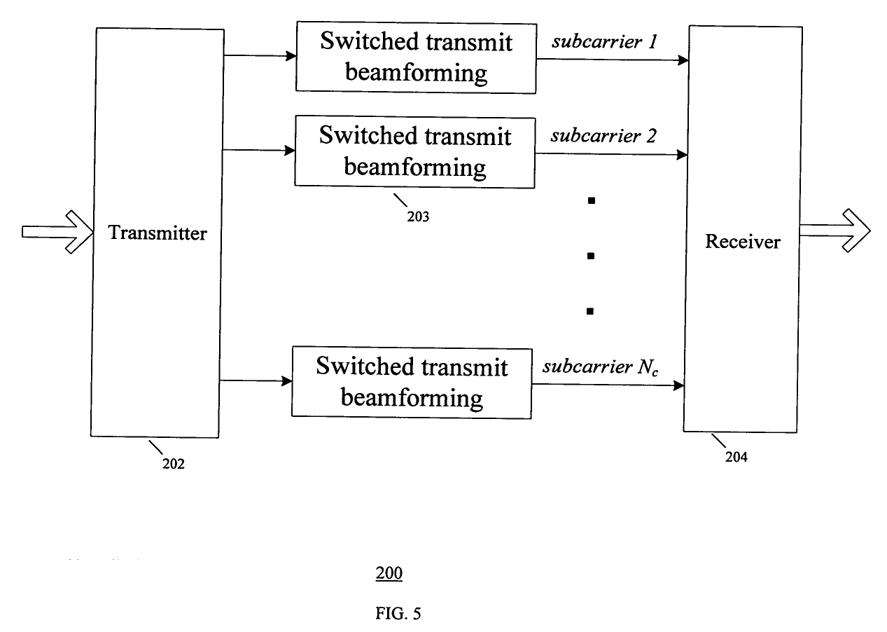

Explicit feedback beamforming according to the present invention can be applied to plain MIMO wireless communication systems as well as MIMO OFDM wireless communication systems. For MIMO OFDM systems, the explicit feedback beamforming method is applied separately for different subcarriers. FIG. 5 shows a functional block diagram of a wireless MIMO OFDM communication system 200 including a transmitter 202 (initiator) and a receiver 204 (responder) that implement channel estimation via explicit channel feedback transmit beamforming by quantizing the right singular matrix, according to an embodiment of the present invention. The example in FIG. 5 illustrates that multiple (N_{C}) orthogonal subcarriers (subcarrier 1, . . . , subcarrier N_{c}) are formed through switched transmit beamforming 203 for each subcarrier using inverse FFT, cyclic prefix insertion at the transmitter and FFT and cyclic prefix removal at the receiver. Quantizing the right singular matrix of the channel in a component-wise manner at the receiver/responder, and then reconstructing the singular vector matrix at the transmitter via a limited amount of feedback, enables simplified codebook design, less receiver complexity, and reduced codebook storage requirement at both transmitter and receiver sides.

Though the initiator includes multiple antennas, the responder may include one or more antennas. In addition, though the responder is shown in the drawings as having multiple antennas, the present invention is also applicable to a single antenna responder.

As such, the present invention provides efficient feedback, simplified codebook design, less receiver complexity, and reduced codebook storage requirement at both the initiator and the responder. Compared with the conventional direct matrix quantization approaches, a component-wise (e.g., column-wise or row-wise) quantization approach according to the present invention provides less receiver complexity and reduced codebook storage requirement. Simpler codebook designs based on the generic vector quantization algorithm can be utilized, as described above.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for beamforming in a wireless communication system including a wireless initiator and a wireless responder, comprising:
estimating a channel matrix at a responder;
obtaining a right singular matrix from the estimated channel matrix by singular value decomposition;
deconstructing the right singular matrix into certain components; and
quantizing the right singular matrix components for feedback to an initiator for beamforming communication.

2. The method of claim 1 further comprising:
feeding back the quantized right singular matrix components from the responder to the initiator; and
reconstructing the right singular matrix from the quantized right singular matrix components at the initiator.

3. The method of claim 2 further comprising normalizing the reconstructed right singular matrix.

4. The method of claim 2 further comprising performing beamforming based on the reconstructed right singular matrix.

5. The method of claim 1 wherein quantizing the right singular matrix components further includes separately quantizing the right singular matrix components by vector quantization.

6. The method of claim 2 wherein reconstructing the right singular matrix from the quantized right singular matrix components further includes reconstructing the right singular matrix by aligning components in the proper order.

7. The method of claim 4 wherein beamforming further includes transmit beamforming based on the reconstructed right singular matrix.

8. The method of claim 7 wherein transmit beamforming further includes normalizing the reconstructed right singular matrix, and transmit beamforming based on the normalized right singular matrix.

9. The method of claim 2 wherein:
deconstructing the right singular matrix includes deconstructing the right singular matrix column-by-column into multiple columns;
quantizing the matrix components includes quantizing the matrix columns for feedback to the initiator;
feeding back the quantized matrix components includes feeding back the quantized matrix columns from the responder to the initiator; and
reconstructing the right singular matrix includes reconstructing the right singular matrix from the quantized right singular matrix columns.

10. The method of claim 9 wherein reconstructing the right singular matrix further includes reconstructing the right singular matrix from the quantized columns by aligning columns in the proper order.

11. The method of claim 10 further performing beamforming communication based on the reconstructed and normalized right singular matrix.

12. The method of claim 11 wherein beamforming further includes normalizing the reconstructed right singular matrix, and transmit beamforming based on the normalized right singular matrix.

13. The method of claim 12 wherein quantizing the right singular matrix further includes quantizing each right singular matrix column using a certain codebook including a group of candidate beamforming vectors.

14. The method of claim 13 wherein quantizing the right singular matrix columns further includes quantizing each right singular matrix column by choosing the closest codeword from a codebook such that a certain distortion metric is minimized.

15. The method of claim 9 wherein the communication system comprises a multiple-input-multiple-output (MIMO) communication system.

16. The method of claim 15 wherein the communication system comprises a MIMO orthogonal frequency division multiplexing (OFDM) communication system.

17. The method of claim 2 wherein:
deconstructing the right singular matrix includes deconstructing the right singular matrix row-by-row into multiple rows;
quantizing the matrix components includes quantizing the matrix rows for feedback to the initiator;
feeding back the quantized matrix components includes feeding back the quantized matrix rows from the responder to the initiator; and
reconstructing the right singular matrix includes reconstructing the right singular matrix from the quantized right singular matrix rows.

18. The method of claim 17 wherein reconstructing the right singular matrix further includes reconstructing the right singular matrix from the quantized rows by aligning rows in the proper order.

19. The method of claim 18 further performing beamforming communication based on the reconstructed and normalized right singular matrix.

20. The method of claim 19 wherein beamforming further includes normalizing the reconstructed right singular matrix, and transmit beamforming based on the normalized right singular matrix.

21. The method of claim 17 wherein quantizing the right singular matrix further includes quantizing each right singular matrix row using a certain codebook including a group of candidate beamforming vectors.

22. The method of claim 21 wherein quantizing the right singular matrix rows further includes quantizing each right singular matrix row by choosing the closest codeword from a codebook such that a certain distortion metric is minimized.

23. The method of claim 17 wherein the communication system comprises a MIMO communication system.

24. The method of claim 23 wherein the communication system comprises a MIMO OFDM communication system.

25. A wireless receiver for beamforming communication, comprising:
an estimator configured for estimating a communication channel matrix;
a decomposition module configured for obtaining a right singular matrix from the estimated channel matrix by singular value decomposition;
a deconstructor configured for deconstructing the right singular matrix into certain components; and
a quantizer configured for quantizing the right singular matrix components for feedback to a wireless transmitter for channel matrix reconstruction and beamforming communication.

26. The receiver of claim 25 wherein the estimator is further configured for estimating the communication channel matrix based on received training symbols from the wireless transmitter.

27. The receiver of claim 25 wherein the quantizer is further configured for separately quantizing the right singular matrix components by vector quantization.

28. The receiver of claim 25 wherein:
the deconstructor is further configured for deconstructing the right singular matrix column-by-column into multiple columns; and
the quantizer is further configured for quantizing the matrix columns for feeding back quantized matrix columns to the wireless transmitter.

29. The receiver of claim 28 wherein the quantizer is further configured for quantizing each right singular matrix column using a certain codebook including a group of candidate beamforming vectors.

30. The receiver of claim 29 wherein the quantizer is further configured for quantizing each right singular matrix column by choosing the closest codeword from a codebook such that a certain distortion metric is minimized.

31. The receiver of claim 25 wherein the receiver comprises a multiple-input-multiple-output (MIMO) MIMO wireless communication receiver.

32. The receiver of claim 31 wherein the receiver comprises a MIMO orthogonal frequency division multiplexing (OFDM) wireless communication receiver.

33. The receiver of claim 25 wherein:
the deconstructor is further configured for deconstructing the right singular matrix row-by-row into multiple rows; and
the quantizer is further configured for quantizing the matrix rows for feeding back quantized matrix rows to the wireless transmitter.

34. The receiver of claim 33 wherein the quantizer is further configured for quantizing each right singular matrix row using a certain codebook including a group of candidate beamforming vectors.

35. The receiver of claim 34 wherein the quantizer is further configured for quantizing each right singular matrix row by choosing the closest codeword from codebook such that a certain distortion metric is minimized.

36. A wireless transmitter for beamforming communication, comprising:
a reconstructor configured for reconstructing a right singular channel matrix using quantized singular channel matrix components from a wireless receiver; and
a beamformer configured for determining a beamforming vector based on the reconstructed quantized singular channel matrix for beamforming communication.

37. The transmitter of claim 36 wherein the beamformer is further configured for steering transmit data in the spatial domain.

38. The transmitter of claim 37 wherein the beamformer is further configured for transmit beamforming based on the reconstructed quantized channel matrix.

39. The transmitter of claim 37 wherein the beamformer is further configured for normalizing the reconstructed right singular matrix.

40. The transmitter of claim 36 wherein the reconstructor is further configured for reconstructing the right singular matrix by aligning components in the proper order.

41. The transmitter of claim 36 wherein the beamformer is further configured for normalizing the reconstructed right singular matrix, and transmit beamforming based on the normalized right singular matrix.

42. The transmitter of claim 36 wherein the reconstructor is further configured for reconstructing the right singular matrix from the quantized columns by aligning columns in the proper order.

43. The transmitter of claim 36 wherein the reconstructor is further configured for reconstructing the right singular matrix from the quantized columns by aligning rows in the proper order.

44. The transmitter of claim 36 wherein the transmitter comprises a multiple-input-multiple-output (MIMO) wireless communication transmitter.

45. The transmitter of claim 44 wherein the transmitter comprises a MIMO orthogonal frequency division multiplexing (OFDM) wireless communication transmitter.
